(19) United States
(12) Patent Application Publication
(10) Pub. No.: US 2004/0260824 A1
(43) Pub. Date: Dec. 23, 2004

(54) Internet telephony call agent

(76) Inventors: Francois Berard, Quebec (CA); Steven Weisz, Quebec (CA); Paul Lemay, Quebec (CA)

Correspondence Address: Lorusso Loud & Kelly, 440 Commercial Street, Boston, MA, 02109, US

(21) Appl. No.: 10/478,781

(22) PCT Filed: May 23, 2002
(86) PCT No.: PCT/CA02/00765

(30) Foreign Application Priority Data
May 23, 2001 (CA) 2,348.242

(51) Int. Cl. G06F 15/16

(52) U.S. Cl. 709/230; 709/202

(57) ABSTRACT

This invention concerns an autonomus media termination centric signaling architecture that takes advantage of both a peer-to-peer signaling protocol such as the SIP and Master/Slave protocols such as MGCP/Megaco/NCS. More specifically, the present invention describes an Internet telephony agent comprising a user agent call manager including a user agent stack for communication with a peer, a master stack, and a multi-protocol call manager for communication between the user agent stack and the master stack; and a media termination coupled to the user agent call manager including a hardware manager, and a slave stack for communication between the master stack and the hardware manager. The user call manager and the media termination of Internet telephony agent may be tightly coupled or loosely coupled, allowing the inter-operation of the Internet telephony agent with both SIP and MGCP/Megaco/NCS media terminations.

### FIELD OF THE INVENTION

The present invention relates to Internet telephony. More specifically, it relates to a multi-protocol Internet telephony call agent.

### BACKGROUND OF THE INVENTION

IP (for “Internet Protocol”) gateways are commonly known in the field of Internet telephony as packet switching entities. Some of such switching entities provide voice communications over IP (“VoIP”)-based networks for analogue phones.

An example of such entities is the APA III-4 provided by Mediatrix Telecom Inc., which allows connection of four analogue lines.

Gateways such as the APA III-4, for example, allow VoIP communications. A number of variants of such gateways are available to support various IP telephony signaling protocols proposed by the IETF (“Internet Engineering Task Force”) and the ITU-T (“Telecommunication Standardization Sector of the International Telecommunications Union”).

Two specific ones of these protocols are known as the “Session Initiation Protocol” or SIP (RFC 2543), which is a peer-to-peer signaling protocol and the “Media Gateway Control Protocol” or MGCP/Megaco (RFC 2705 and RFC 3015), which are master/slave signaling protocols.

A peer-to-peer signaling protocol such as SIP is known not to inherently inter-operate with a master-slave protocol such as MGCP/Megaco Media, since peer-to-peer and master-slave signaling protocols are fundamentally different.

More precisely, on the one hand, in a peer-to-peer protocol, each peer is an autonomous entity that regulates its own network behavior. For instance, in SIP, each peer is called a “SIP user agent”. An IP telephony network based on a peer-to-peer protocol is described hereinbelow with reference to FIGS. 1 and 2.

On the other hand, in a master/slave signaling protocol, a master controls the network behavior of a set of slaves hardware media terminations accessible through a “media gateway” (MG). For instance, in MGCP/Megaco, the master is identified as a “call agent” or a “media gateway controller” (MGC). An IP telephony network based on a master/slave protocol is described hereinbelow with reference to FIG. 3.

Since the general term “media termination” is believed to be well known in the art, it will not be described herein in more detail. However, it is to be noted that in the following, this generic term will have to be construed so as to include analogue lines.

Turning first to FIGS. 1 and 2 of the appended drawings, a SIP network according to the prior art will be described in more detail.

The basic SIP architecture is client/server in nature. As shown in FIG. 1, a SIP network 10 comprises a plurality of peers including SIP telephones 11 directly connected to an IP based network and analog telephones 11 connected to the IP based network via SIP gateways 13, a SIP proxy server 16, a SIP redirect server 18 and a registrar 20.

The SIP telephones 11 and the SIP gateways 13 implement SIP user agents 12 (or SIP endpoints) (see on FIG. 2) that act as clients (UACs) when initiating request and as servers (UASs) when responding to requests. Each user agents 12 allows direct communication with other user agents or via an intermediate server (not shown). User agents 12 also store and manage call states.

As shown in FIG. 2, a SIP user agent 12 generally comprises the following generic components:

a SIP user agent stack 22;

a call manager 24; and

a hardware manager 26.

The SIP user agent stack 22 implements the SIP protocol, while the call manager 24 controls the call behavior of a specific media termination hardware manager 26.

Returning to FIG. 1, the SIP intermediate server has the capability to behave as a proxy server or as a redirect server. SIP proxy servers 16 forward requests from the user agents 12 to another SIP server or user agent within the network and also retain information for billing/accounting purposes for example. SIP redirect servers 18 respond to client requests and inform them of a requested server's address. As it is conventionally known in the art, numerous hops can take place until reaching a final destination.

The high flexibility of the SIP architecture 10 allows the servers to contact external location servers to determine user or routing policies, and therefore, does not bind the user into only one scheme of a user's location. In addition, to maintain scalability, the SIP servers can either maintain state information or forward requests in a stateless fashion.

The SIP network 10 may also include a SIP registrar 20. The user agent 12 sends a registration message to the SIP registrar 20, which then stores the registration information in a location service via a non-SIP protocol. Once the information is stored, the SIP registrar 20 sends the appropriate response back to the user agent 12 or 14.

In summary, there are a number of servers that offer services to the SIP peers embodied by the user agents 12 and 14, among which:

the registrar 20 is a server that accepts registered requests. Registrars 20 are needed to keep track of a current location of a user. An IP address of a user may change under a number of situations. In order to reach the user from his SIP address, the registrar 20 maintains a mapping between SIP addresses and IP addresses in the SIP based network 10;

the proxy 16 acts as a server on one side, for receiving requests, and as a client on the other side, for possibly sending requests. The proxy 16 can forward a request without any change to its final destination, or change some parameters before passing on the request; and

the redirect server 18 can be used in conjunction with a registrar 20 to redirect calls to at least one the current location of a caller.

Since, SIP servers and networks are believed to be well known in the art, they will not be described herein in more detail.

Turning now to FIG. 3 of the appended drawings, a MGCP based network 30 is presented.

The MGCP based network 30 is mainly composed of MGCP gateways 32, 34, each having a plurality of analog telephones 31, 33 respectively connected thereto and acting as slaves, and MGCP call agents 36, 38, which essentially act as masters that monitor and control the MGCP gateways 32, 34. More specifically, the call agent 36 monitors and controls the gateway 32, and the call agent 38 monitors and controls the gateway 34.

MGCP can be seen as a master/slave protocol requiring a tight coupling between endpoints embodied by the MGCP gateways or MG (for “Media Gateway”) 32 or 34, and servers embodied by MGCP call agents or MGC (for “Media Gateway Controller”) 36 or 38.

Similarly to SIP and H.323 for example, MGCP relies on a variety of other existing protocols such as SDP (Subscriber Distribution Point SDP) for describing media aspects of a call, and RTP/RTCP (Real-Time Protocol/Real-Time Control Protocol) that is used by MGCP gateways 32, 34, for handling a real-time transport of media streams.

In a MGCP based network 30, a MGCP call agent 36 or 38 is mandatory and manages the calls and conferences and supports the services provided. The MGCP gateways 32 and 34 are unaware of the calls and conferences and do not maintain call states. The MGCP gateways 32 and 34 are expected to execute commands sent by the MGCP call agents 36 or 38. An MGCP based network 30 implies that the MGCP call agents 36 and 38 synchronize with each other sending coherent commands to the MGCP gateways 32 and 34 under their control. The MGCP based network 30 does not define a mechanism for synchronizing the MGCP call agents 36 or 38.

Therefore, in a MGCP based network 30, the main entities are endpoints (MGCP gateways 32 and 34), and connections (provided by MGCP call agents 36 and 38).

On one hand, a MGCP based network 30 assumes a connection model where the basic constructs of endpoints and connections are used for establishing voice paths between calling participants. Generally stated, endpoints are sources or sinks of data and can be physical or virtual. Physical endpoint creation requires hardware installation while software is sufficient for creating a virtual endpoint. An interface on a gateway that terminates a trunk connected to a public switched telephone network (PSTN) switch is an example of a physical endpoint. An audio source in an audio-content server is an example of a virtual endpoint.

On the other hand, connections may be either point-to-point or multi-point. A point-to-point connection associates two endpoints 32, 34. Once this association is established between the two endpoints 32, 34, data transfers between these endpoints 32, 34 can begin. A multi-point connection is established by connecting the endpoint 32, 34 to a multi-point session. Connections can be established over several types of bearer networks: audio packet transmission using RTP and UDP (“User Datagram Protocol”) over a TCP/IP (“Transmission Control Protocol/Internet Protocol”) network, audio packet transmission using AAL2 (ATM Adaptation Layer 2) or another adaptation layer over an ATM network (for “Asynchronous Transfer Mode”), and transmission of packets over an internal connection. For both point-to-point and multi-point connections the endpoints 32, 34 can be in separate gateways or in the same gateway.

The control primitives for operations in the MGCP based network 30 are signals sent from the call agents 36, 38, which are the masters, to the gateways 32, 34, which are the slaves, and events sent from the gateways 32, 34 to the call agents 36, 38. The concepts of signals and events are used for establishing and tearing down calls. Operations are performed by applying signals to, and detecting events from endpoints 32, 34. A call agent 36, 38 initiates transactions to manage/configure gateways 32, 34 endpoints using MGCP commands. Gateways 32, 34 send responses to call agents 36, 38 transaction requests using either a notification or a restart command. Signals and events needed to support a specific telephony function or type of endpoints are grouped into event/signal packages.

Following the above review, it appears obvious that peer-to-peer and master/slave endpoints (media terminations) can not inter-operate.

It appears that there still is a need for a multi-protocol Internet telephony call agent that would allow peer-to-peer and master/slave endpoints to inter-operate.

### SUMMARY OF THE INVENTION

The present invention provides for a system and method that allow interoperability between a peer-to-peer signaling protocol such as SIP and H.323 and a master-slave protocol such as MGCP, Megaco Media, and NCS (Network Call Signaling) protocol.

According to a first aspect of the present invention, there is provided an Internet telephony agent comprising:

a user agent call manager; the user agent call manager including a user agent stack for communication with a remote user agent, a master stack, and a multi-protocol call manager for communication between the user agent stack and the master stack; and

a media termination coupled to the user agent call manager including a hardware manager, and a slave stack for communication between the master stack and the hardware manager.

According to a second aspect of the present invention, there is provided an Internet telephony call agent comprising a plurality of user agent call manager, each including a user agent stack for communication with a remote user agent, a master stack, and a multi-protocol call manager for communication between the user agent stack and the master stack; the master stack allowing communication with a media termination; whereby, each of the plurality of user agent call manager allowing communication between a media termination connected to the Internet telephony call agent and a remote user agent, and communication between two of the plurality of the user agent call manager.

According to a third aspect of the present invention, there is provided a method for managing an Internet telephony command received from a remote user agent, comprising:

inputting the command to a user agent stack;

the user agent stack parsing the command so as to yield a parsed command, and issuing the parsed command to a multi-protocol call manager;

the multi-protocol call manager processing the parsed command yielding a transaction, and issuing the transaction to a master stack;

the master stack issuing the transaction to a slave stack; and

the slave stack issuing a hardware command to the hardware manager.

According to a fourth aspect of the present invention there is provided a method for issuing to an Internet telephony endpoint hardware manager a command received from a remote user agent, comprising:

inputting the command received from a remote user agent to a user agent stack;

the user agent stack parsing the command so as to yield a parsed command, and issuing the parsed command to a multi-protocol call manager;

the multi-protocol call manager processing the parsed command yielding a transaction, and issuing the transaction to a master stack; the processing the parsed command including translating the command from an Internet telephony protocol compatible with the user agent stack to an Internet telephony protocol compatible with the master stack;

the master stack issuing the transaction to a slave stack; and;

the slave stack issuing a hardware command to the hardware manager.

The present invention is advantageous since it allows SIP or other peer-to-peer signalling protocol user agent media terminations to inter-operate with MGCP/Megaco or other master/slave media terminations.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1, which is labeled “prior art”, is a block diagram illustrating the general configuration of a SIP network;

FIG. 2, which is labeled “prior art”, is a block diagram illustrating a SIP User Agent according to the prior art;

FIG. 3, which is labeled “prior art”, is a block diagram illustrating the general configuration of a MGCP network;

FIG. 4 is a block diagram illustrating a SIP user agent according to an embodiment of a first aspect of the present invention;

FIG. 5 is a block diagram illustrating a multi-protocol Call Agent, incorporating the SIP user agent of FIG. 4 and illustrated interfacing with both a Megaco user agent and a SIP user agent; and

FIGS. 6A and 6B illustrate a flowchart of a method for managing an Internet telephony command according to an embodiment of a second aspect of the present invention.

### DESCRIPTION OF THE PREFERRED EMBODIMENT

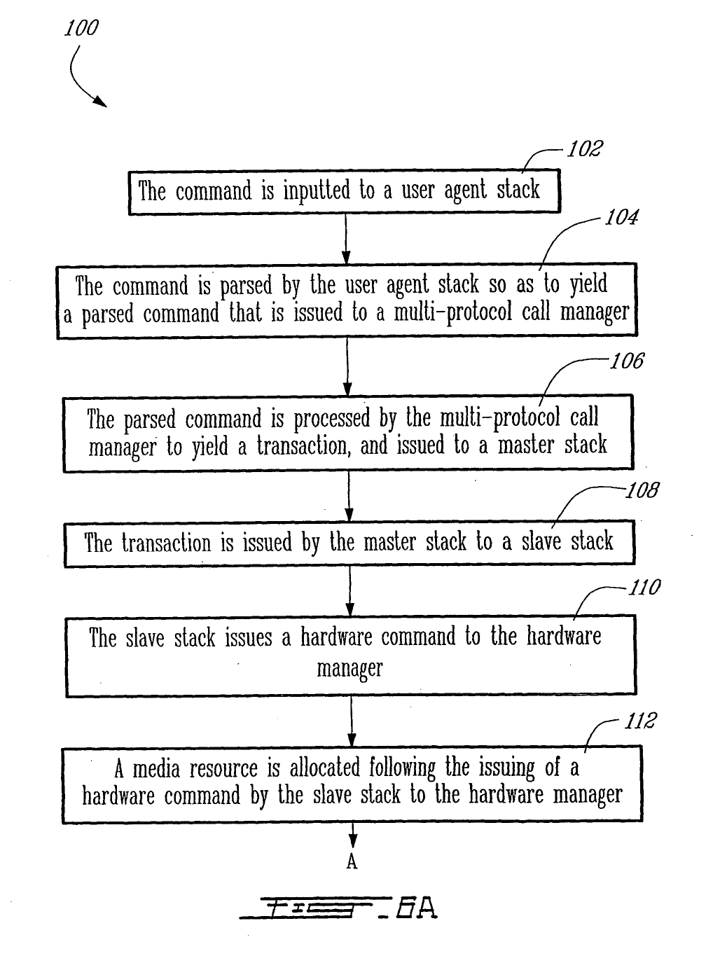

Turning now to FIG. 4 of the appended drawings, an Internet telephony agent, according to a first embodiment of a first aspect of the present invention, is illustrated.

According to the first embodiment, the Internet telephony agent is in a tightly coupled mode, in the form of a SIP user agent 40.

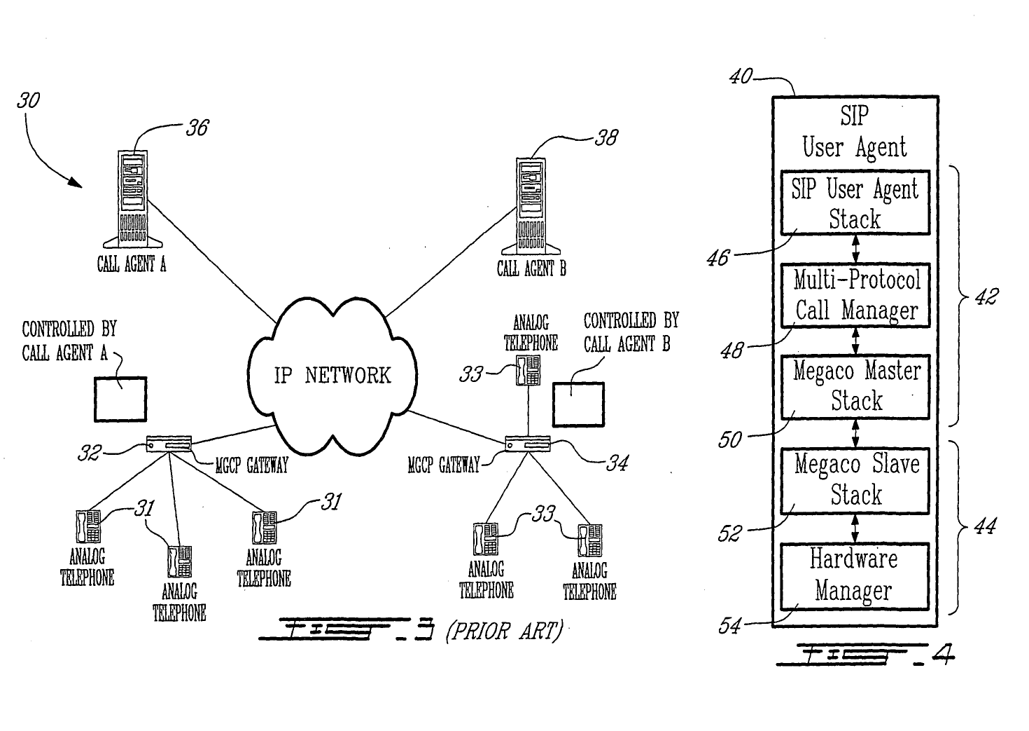

Generally described, on a signaling protocol level, the SIP user agent 40 generally operates as described above with reference to FIG. 2: it initiates (sends) requests and waits for responses, and it can also receive requests and issue responses, according to the actions of the user it represents.

On a user interface level, the user agent 40 can be implemented in an IP telephone, a program running on a personal computer, or a wristwatch configured so as to communicate in a computer network, for example. The user agent 40 may be in the form of software that can be embedded in any type of communication equipment. Generally, the user agent 40 will interact via an interface (not shown) to begin and terminate a multimedia communication with another peer.

Configuring the user agent 40 is therefore dependent on the interface offered to the user. The configuration can be entered via a web page, via a protocol such as SNMP (for “Simple Network Management Protocol”) or by having the user use the interface provided by the device implementing the functionality of the user agent 40, for example. Usually, the user will be able to provide the device with a username, password and a fully qualified domain name or “FQDN” of its home server.

As shown in FIG. 4, the SIP user agent 40 comprises a SIP user agent call manager 42 and a Megaco media termination 44. The SIP user agent call manager 42 further comprises a SIP user agent stack 46; a multi-protocol call manager 48; and a Megaco master stack 50.

The SIP user agent stack 46 is configured so as to send information to a remote SIP user agent (not shown) on a SIP network or receive information therefrom. The remote SIP user agent may be a conventional user agent, such as user agent 12 on FIG. 2, or a user agent according to the present invention.

The SIP user agent communicates with the Megaco master stack 50 via a Multi-protocol call manager 48. The multi-protocol call manager 48 is therefore configured so as to translate and transfer commands between the SIP user agent stack 46 and the Megaco master stack 50. More specifically, the multi-protocol call manager allows translating a command from the SIP protocol to the Megaco protocol.

Globally, the SIP user agent call manager 42 allows interfacing the Megaco media termination 44 with a SIP peer remotely connected over a network.

The Megaco media termination 44 further comprises a Megaco slave stack 52 and a hardware manager 54.

Since Megaco and more specifically master/slave telephony protocol media terminations and hardware managers, as well as their inter-operability, are believed to be well known in the art, they will not be described herein in more detail.

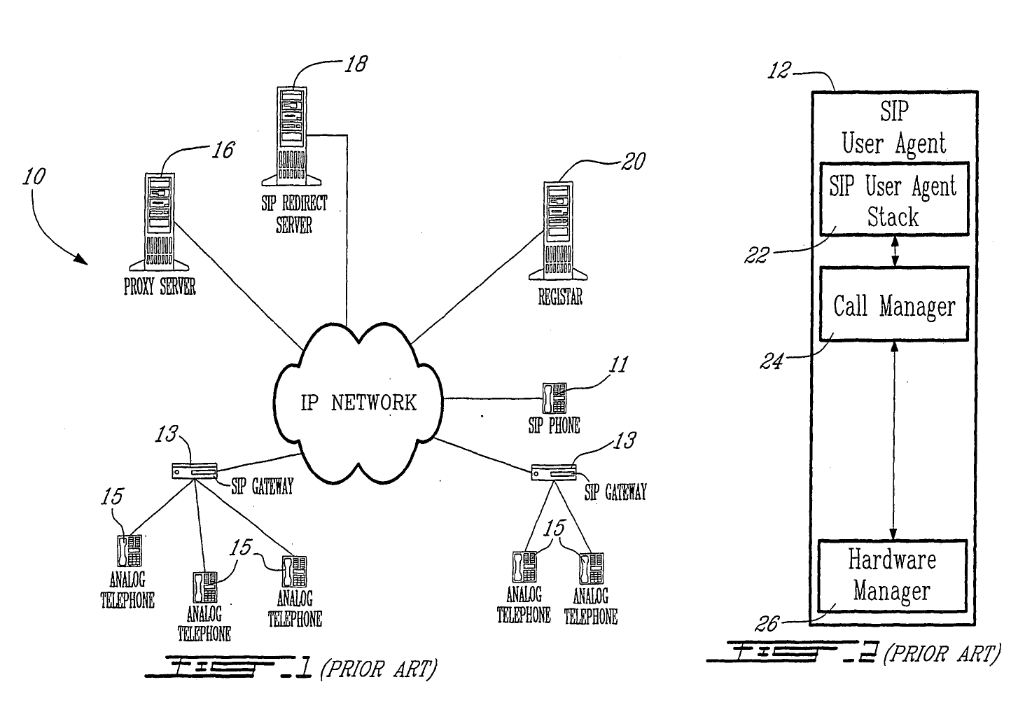

The SIP user agent 40 of FIG. 4 may be implemented for example in a SIP telephone or in a SIP gateway allowing connections of analog phones, both as illustrated in FIG. 1. The user agent 40 allows establishment of a peer-to-peer session with another SIP user agent. The other SIP user agent may be either a conventional SIP user agent, as illustrated in FIG. 2, or another SIP user agent according to the first embodiment of the first aspect of the present invention.

Even though the user agent of FIG. 4 has been illustrated as a SIP user agent, a user agent operating under other peer-to-peer signaling protocol such as H.323 is within the scope of the present invention.

The Internet telephony agent 40 is said to be in a tightly coupled mode since the SIP user agent call manager 42 and the Megaco media termination 44 are both integrated in a single device, for example a SIP gateway or a SIP phone. According to the tightly coupled mode, the SIP user agent call manager 42 controls a specific hardware manager 54 running in the same network node.

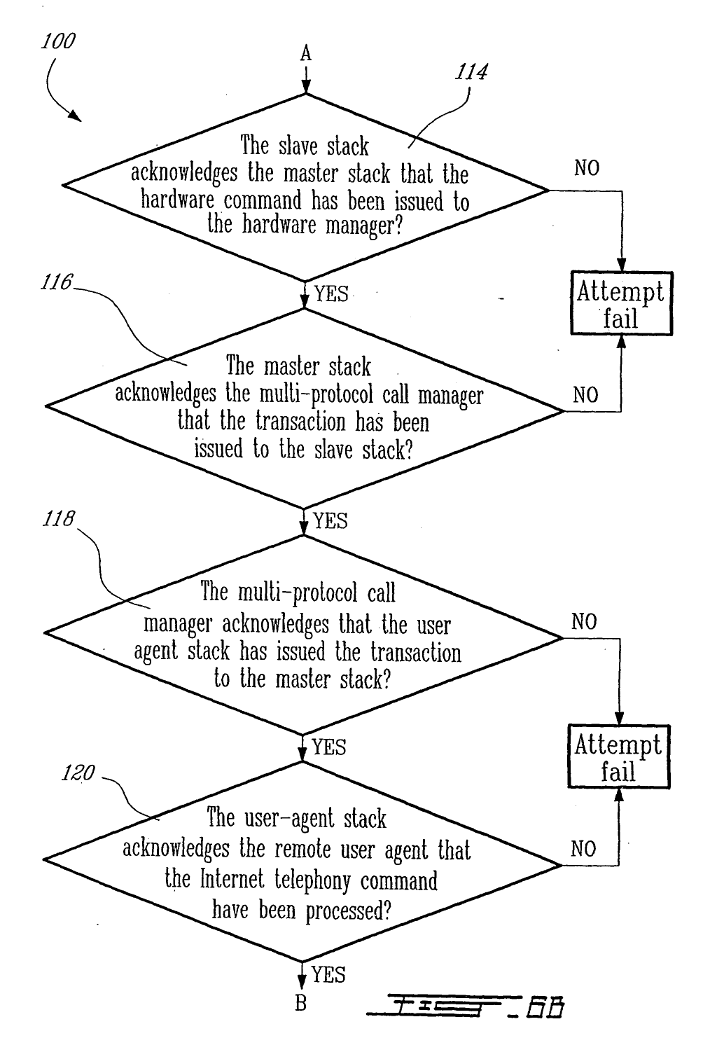

In addition to the tightly coupled mode, illustrated in reference to the user agent 40 of FIG. 4, an Internet agent according to a first aspect of the present invention also allows to support a loosely coupled mode as will be described hereinbelow in relation to FIG. 5.

Turning now to FIG. 5, four Internet agents 60-66, each according to a second embodiment of the first aspect of the present invention are illustrated.

Similarly to the SIP user agent 40, each of the four Internet agents 60-66 comprises a SIP user agent call manager 42, and a Megaco media termination 44.

Each of the four Internet agents 60-66 is said to be in a loosely coupled mode, since the SIP user agent call manager 42 and the Megaco media termination 44 are not integrated in a single device.

Indeed, the four SIP user agent call managers are integrated in a first workstation (or server) 68, configured so as to act as a call agent. The four corresponding media terminations are integrated in a second workstation 70 configured so as to act as a media gateway.

The loosely coupled mode allows the call manager 42 to control a specific hardware manager 54 both running in the same network node or in a remote network node.

Of course, the number of SIP user agents 42 in the call agent 68 may vary. Also, the second workstation 70 may allow as many hardware (or device) connections as it includes media terminations 44.

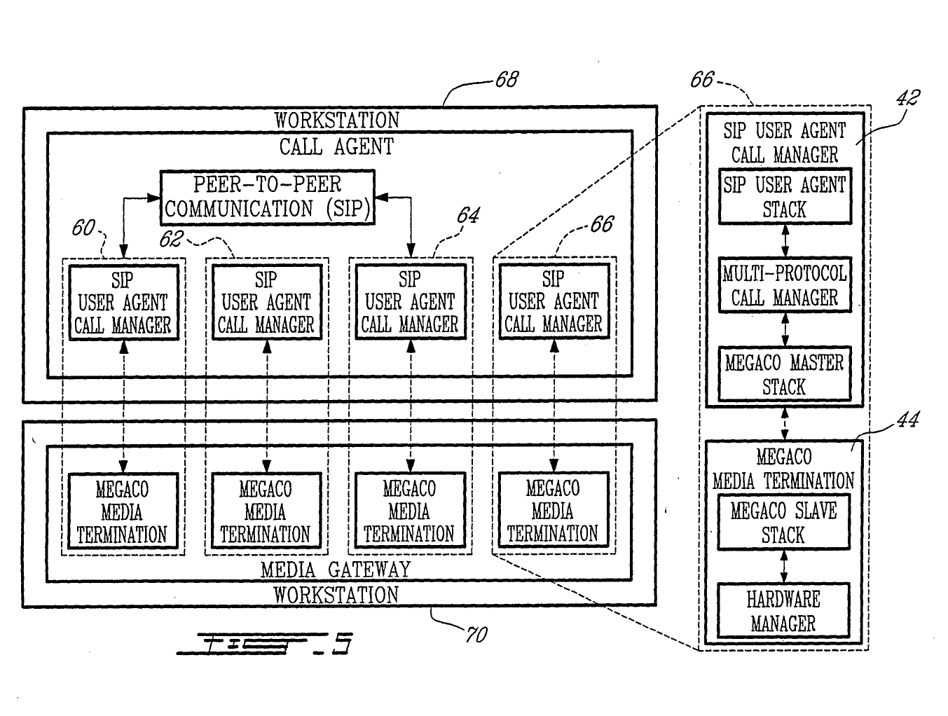

As it becomes now more apparent, the interconnection and functions of the first and second workstations 68-70 are similar to the interconnection and functions of the gateways 32, 34 and call agents 36, 38 of FIG. 3.

It is to be noted that each Megaco media terminations 44 of the media gateway 70 requires a SIP user agent call manager 42 to inter-operate even when establishing communication within the single call agent 68.

Of course, an Internet telephony agent configured in a loosely coupled mode, as illustrated in FIG. 5, may implement other peer-to-peer signaling protocols than SIP, such as H.123, and other master/slave protocols than Megaco, such as MGCP and NCS.

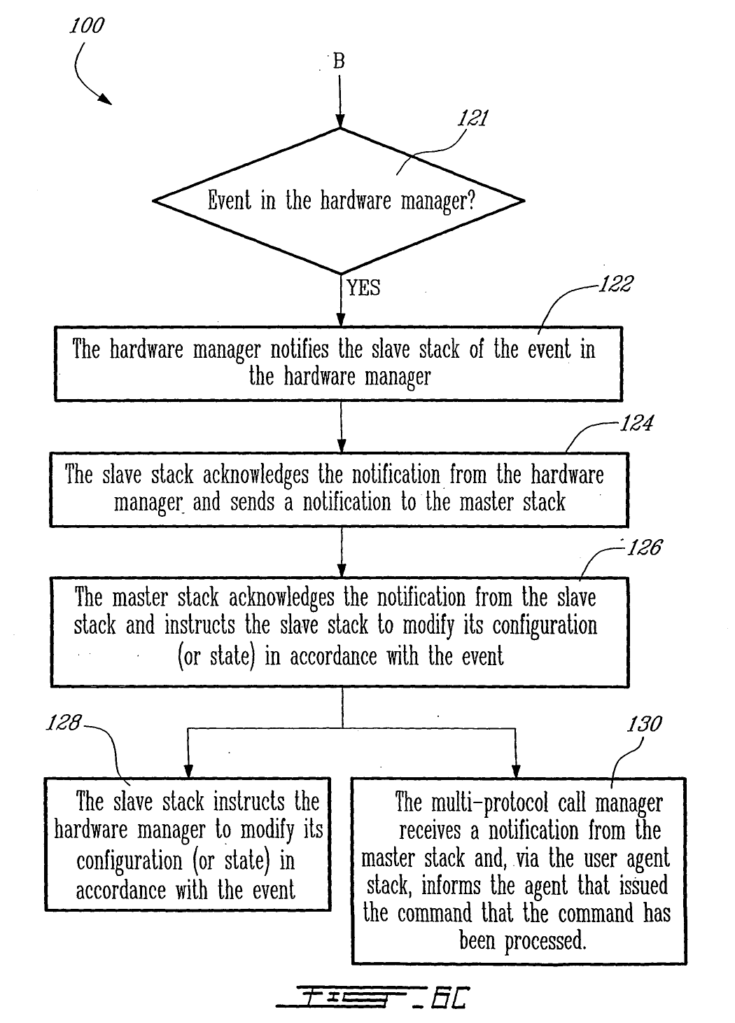

The operation of the Internet telephony agent according to the first aspect of the present invention will now be described, first, with reference to FIG. 6, which generally describes a method for managing an Internet telephony command, according to an embodiment of a second aspect of the present invention, and then according to two specific examples of establishment of a session.

As illustrated in FIG. 6, the method 100 allows for managing an Internet telephony command received from a remote user agent and/or for issuing a command to such a remote user agent.

The term “command” refers to any exchange of information between two Internet telephony endpoint devices having the purpose to change the state or configuration of such devices. Those commands are well known in the art, and will not be detailed herein.

Generally stated, the method 100 comprises:

the command is inputted to a user agent stack (step 102);

the command is parsed by the user agent stack so as to yield a parsed command that is issued to a multi-protocol call manager (step 104);

the parsed command is processed by the multi-protocol call manager to yield a transaction, and issued to a master stack (step 106);

the transaction is issued by the master stack to a slave stack (step 108);

the slave stack issues a hardware command to the hardware manager (step 110);

a media resource is allocated following the issuing of a hardware command by the slave stack to the hardware manager (step 112);

the slave stack acknowledges the master stack that the hardware command has been issued to the hardware manager (step 114);

the master stack acknowledges the multi-protocol call manager that the transaction has been issued to the slave stack (step 116);

the multi-protocol call manager acknowledges that the user agent stack has issued the transaction to the master stack (step 118);

the user-agent stack acknowledges the remote user agent that the Internet telephony command have been processed (step 120);

As illustrated in FIG. 6A, a failed attempt message is forwarded to the user agent that issued the command whenever one of steps 114-120 is unsuccessful. Moreover, in those cases, the processing of the command is interrupted.

Following the generation of an event in the hardware manager implemented in the device receiving the command:

the hardware manager notifies the slave stack of the event in the hardware manager (step 122);

the slave stack acknowledges the notification from the hardware manager and sends a notification to the master stack (step 124);

the master stack acknowledges the notification from the slave stack and instructs the slave stack to modify its configuration (or state) in accordance with the event (step 126);

the slave stack instructs the hardware manager to modify its configuration (or state) in accordance with the event (step 128); and

the multi-protocol call manager receives a notification from the master stack and, via the user agent stack, informs the agent that issued the command that the command has been processed (step 130).

It is to be noted that all the above steps are executed by a single Internet telephony agent according to the first aspect of the present invention.

Interestingly, in step 108, when the Internet telephony agent is configured in the loosely coupled mode, as illustrated in FIG. 5, the master stack can issue the transaction to a slave stack over an IP network.

Of course, the expression hardware manager is not intended to be limiting in any way and should be so construed as to include both software and hardware entities that are configured so as to command and/or control a physical communication device or a communication software.

The steps of method 100 will be explained in more detail with reference to the next two examples of application.

The first example describes what occurs during the establishment of a session initiated by a remote SIP user agent, to a device embodying an Internet telephony agent in the tightly coupled mode according to the first aspect of the present invention as described hereinabove (see FIG. 5). Of course, the remote SIP user agent may be either according to the prior art, or according to the first aspect of the present invention.

Considering first, for the first example, the two following entities:

(1) a remote SIP user agent, which will be hereinafter in this first example referred to as the caller; and

(2) a local access device, which will be hereinafter in this first example referred to as the callee, conforming to the tightly couple mode defined hereinabove.

The following sequential actions describe interactions between the different layers defined hereinabove in relation to FIG. 4, in the case of this first specific example:

1. the caller initiates a session by sending a SIP INVITE command to the callee over the IP network. The format of the command is an ASCII string of characters conforming to the SIP protocol;

2. the command is received by the callee and is input to the SIP user agent stack (“SUAS”), which parses the raw SIP message and issues the SIP INVITE command to the Multi-Protocol Call Manager (“MPCM”);

3. the MPCM processes the SIP INVITE command and issues a transaction containing two Add commands to the Megaco master stack (MMS):

a. one to create and add an ephemeral termination or media stream to the context. The media stream will initially be set to inactive.

b. one to add a physical termination or analog line to the context. This command will also contain a signals parameter instructing the analog line to play a ring tone and an events parameter containing an off hook event to notify;

4. the MMS issues the transaction created in step 3 to the Megaco slave stack (“MSS”);

5. the MSS issues a create connection to the hardware manager (“HM”) for the ephemeral termination and adds the physical termination to the context;

6. the HM, assuming successful creation of the ephemeral termination, returns a SDP parameter for the media stream and attempts to start playing the ring tone; and

7. if the ring tone is successfully started and media resources are allocated, the process goes on to step 13 hereinbelow.

The following steps outline the steps taken when the attempt to create the callee side of the call fails:

8. if the ring tone is not successfully started due to a glare condition or media resources could not be allocated for example, the MSS will NACK (“Negative Acknowledgment”) the Add command(s) sent by the MMS in step 3 hereinabove;

9. the MMS informs the MPCM that the Invite issued in step 2 has been rejected and the reason for the rejection;

10. the MPCM instructs the SUAS to send a SIP response to the caller over the IP Network nacking the INVITE sent in step 1;

11. the SUAS encodes the response into a SIP acknowledgment and sends it to the caller; and

12. the caller, after a predetermined time, sends an acknowledgement for the response sent in step 11. In case when the attempt to establish the call fails, the process comes to an end.

The following steps outline the steps taken when the attempt (step 7 hereinabove) to create a callee side of the call succeeds:

13. the MSS sends an acknowledgment to the MMS containing the SDP (“Service Data Point”) parameter for the currently inactive media stream, and an acknowledgment to the Add command for the physical termination;

14. the MSS notifies the MMS that the transaction sent in step 3 is successful and passes the SDP parameter for the media stream;

15. the MMS notifies the MPCM that the Invite issued in step 2 has succeeded and passes the SDP parameter for the media stream; and

16. the MPCM instructs the SUAS to send a SIP provisional response to the caller over the IP network informing it that the callee's “phone” is “ringing”.

At this point, the system is in stand-by until the callee picks up the “phone”, thus triggering the following steps:

17. the callee picks up the “phone” which generates an off hook event in the HM;

18. the HM stops the ring tone signals and notifies the MSS of the off hook event;

19. the MSS sends a Notify command to the MMS of the off hook event;

20. the MMS acknowledges the Notify and issues a Modify command to the MSS instructing it to set the media stream mode to send/receive;

21. the MSS instructs the HM to set the media stream to send receive and acknowledges the Modify command;

22. the MMS informs the MPCM that the “phone” is now off hook;

23. the MPCM upon receiving the notification and being aware of the pending INVITE sent by the caller in step 1, instructs the SUAS to send the SIP response “200 OK” to the caller with the SDP parameters for the media stream obtained in step 15; and

24. the caller, after a predetermined time, sends an acknowledgement for the response sent in step 23. The call is now successfully established.

The following second example will describe what occurs during the establishment of a session initiated by a remote SIP user agent, to a system embodying the Internet telephony agent in the loosely coupled mode according to the first aspect of the present invention described hereinabove. The steps are almost identical to the ones of the first example given hereinabove. However, the Megaco transactions passed between the Megaco master stack (MMS) and the Megaco slave stack (MSS) are passed as ASCII strings over the IP network.

Consider now, for the second example, the three following entities:

(1) a remote SIP user agent, hereinafter in this second example referred to as the caller;

(2) a local call agent; and

(3) a Megaco gateway, hereinafter in this second example referred to as the callee.

The following sequential actions describe interactions between the different layers defined in FIG. 5 discussed hereinabove, in the case of this second specific example:

1. the caller initiates a session by sending a SIP INVITE command to the callee over the IP network. The format of the command is an ASCII sting of characters conforming to the SIP protocol;

2. the command is received by callee and is input to the SIP user agent stack (SUAS), which parses the raw SIP message issues, an Invite command to the Multi-Protocol Call Manager (MPCM);

3. the MPCM processes the Invite command and issues a transaction containing two Add commands to the Megaco master stack (MMS):

a. one to create and add an ephemeral termination (media stream) to the context. The media stream is initially set to inactive.

b. one to add a physical termination (analog line) to the context. The command will also contain a signals parameter instructing the analog line to play the ring tone and an events parameter containing the off hook event to notify;

4. the MMS encodes into a Megaco message (ASCII string) and transmits it over the IP network to a Megaco gateway;

5. the Megaco slave stack (MSS) receives the message sent by the MMS of the call agent, parses and analyses it;

6. the MSS issues a create connection to the hardware manager (HM) for the ephemeral termination, and adds the physical termination to the context;

7. the HM, assuming successful creation of the ephemeral termination, returns the SDP parameter for the media stream and attempts to start playing the ring tone; and

8. if the ring tone is successfully and media resources were allocated, then the process goes on along the lines of step 14 hereinbelow.

The following steps outline the steps taken when the attempt to create the callee side of the call fails:

9. if the ring tone is not successfully started due to a glare condition or media resources could not be allocated, the MSS will nack the Add command(s) sent by the call agent in step 3, by encoding a response containing the NACK and sending it over the IP network to the call agent;

10. the MMS of the call agent receives and parses the response sent by the Megaco gateway and informs the MPCM that the Invite issued in step 2 has been rejected including the reason for rejection;

11. the MPCM instructs the SUAS to send a SIP response to the caller over the IP network nacking the INVITE sent in step 1;

12. the SUAS encodes the response into a SIP acknowledgment and sends it to the caller; and

13. the caller, after a predetermined time, sends an acknowledgment for the response sent in 12. In the case when the attempt to establish the call fails, the process comes to an end.

The following steps outline the steps taken when the attempt to create the callee side of the call (step 8 hereinabove) succeeds:

14. the MSS sends an acknowledgment to the Add commands sent by the call agent in step 4, containing the SDP parameter for the currently inactive media stream, and an acknowledgment to the Add command for the physical termination, to the call agent over the IP network;

15. the MMS in the call agent parsers the transaction reply;

16. the MMS informs the MPCM that the Invite issued in step 2 has succeeded and passes the SDP parameter for the media stream; and

17. the MPCM instructs the SUAS to send a SIP provisional response to the caller over the IP Network informing it that the callee's “phone” is “ringing”.

At this point, the system is in stand-by until the callee picks up the “phone”:

18. the callee picks up the “phone” which generates an off hook event in the HM;

19. the HM stops the ring tone signals and notifies the MSS of the off hook event;

20. the MSS sends a Notify command to the call agent of the off hook event;

21. the MMS of the call agent acknowledges the Notify and transmits a Modify command to the Megaco gateway instructing it to set the media stream mode to send/receive;

22. the MSS upon parsing the Modify command, instructs the HM to set the media stream to send receive and acknowledge the Modify command;

23. the MMS informs the MPCM that the “phone” is now off hook;

24. the MPCM upon receiving the notification and being aware of the pending INVITE sent by the caller in step 1, instructs the SUAS to send the SIP response “200 OK” to the caller with the SDP parameters for the media stream obtained in step 16; and

25. the caller, after a predetermined time, sends an acknowledgment for the response sent in step 23. The call is now successfully established.

Even though the above two examples have been provided with reference to the establishment of a session initiated by a SIP user agent, the present invention also allows for the establishment of a session initiated by a slave, such as an analog telephone via a MGCP Gateway (see for example, the analog telephones 31, 33 and MGCP gateways 32, 34 on FIG. 3). In that particular case, the call agents handling the communication include SIP user agent call managers as illustrated in FIG. 5.

Interestingly, people in the art will appreciate that the present invention may provide a configuration of the server varying from the very tightly coupled model described herein to a completely uncoupled system for example, since every component thereof may be distributed across a network.

Although the present invention has been described hereinabove by way of preferred embodiments thereof, it can be modified without departing from the spirit and nature of the subject invention, as defined in the appended claims.

What is claimed is:

1. An Internet telephony agent comprising:
a user agent call manager; said user agent call manager including a user agent stack for communication with a remote user agent, a master stack, and a multi-protocol call manager for communication between said user agent stack and said master stack; and
a media termination coupled to said user agent call manager including a hardware manager, and a slave stack for communication between said master stack and said hardware manager.

2. An Internet telephony agent as recited in claim 1, wherein said user agent call manager and said remote user agent are configured for communication under a peer-to-peer Internet telephony protocol.

3. An Internet telephony agent as recited in claim 2, wherein said peer-to-peer Internet telephony protocol is selected form a group consisting of Session Initiation Protocol (SIP) and H.323.

4. An Internet telephony agent as recited in claim 1, wherein said master and slave stacks are configured for communication under a master/slave Internet telephony protocol.

5. An Internet telephony agent as recited in claim 4, wherein said master/slave Internet telephony protocol is selected from a group consisting in a Media Gateway Control Protocol (MGCP) master tack, a Megaco master stack, and a Network Call Signaling (NCS) master stack.

6. An Internet telephony agent as recited in claim 1, wherein said media termination is tightly coupled to said user agent call manager.

7. An Internet telephony agent as recited in claim 6, wherein said Internet telephony agent is an Internet telephony peer-to-peer user agent.

8. An Internet telephony agent as recited in claim 7, wherein said Internet telephony peer-to-peer user agent is selected from a group comprising a SIP user agent and a H.323 user agent.

9. An Internet telephony agent as recited in claim 7, wherein said Internet telephony peer-to-peer agent is implemented in one of an Internet Protocol (IP) telephone, an IP telephony Gateway, and a computer program.

10. An Internet telephony agent as recited in claim 1, wherein said media termination is loosely coupled to said user agent call manager.

11. An Internet telephony agent as recited in claim 10, said media termination and said user agent call manager are located on different nodes of a network.

12. An Internet telephony agent as recited in claim 10, wherein said media termination is part of a first device, and said user agent call manager is part of a second device.

13. An Internet telephony agent as recited in claim 12, wherein said first device is a media gateway, and said second device is a call agent.

14. An Internet telephony agent as recited in claim 1, wherein said hardware manager includes at least one of said hardware and software.

15. An Internet telephony call agent comprising a plurality of user agent call manager, each including a user agent stack for communication with a remote user agent, a master stack, and a multi-protocol call manager for communication between said user agent stack and said master stack; said master stack being coupled to a media termination;
whereby, each of said plurality of user agent call manager allowing communication between a media termination connected to said Internet telephony call agent and a remote user agent, and communication between two of said plurality of said user agent call manager.

16. A method for managing an Internet telephony command received from a remote user agent, comprising:
inputting the Internet telephony command to a user agent stack;
said user agent stack parsing the command so as to yield a parsed command, and issuing said parsed command to a multi-protocol call manager;
said multi-protocol call manager processing said parsed command yielding a transaction, and issuing said transaction to a master stack;
said master stack issuing said transaction to a slave stack; and
said slave stack issuing a hardware command to said hardware manager.

17. A method as recited in claim 16, wherein said transaction yielded by said multi-protocol call manager processing said parsed command includes a first add command to create and add an ephemeral termination and a second add command to create and add a physical termination, both the hardware manager.

18. A method as recited in claim 16, wherein said master stack issuing said transaction to said salve stack over an Internet Protocol (IP) network.

19. A method as recited in claim 16, wherein said remote user agent is an Internet telephony agent as recited in claim 1.

20. A method as recited in claim 16, wherein said remote user agent is selected from a group comprising a SIP user agent and a H.323 user agent.

21. A method as recited in claim 16, further comprising allocating a media resource following said slave stack issuing a hardware command to said hardware manager.

22. A method as recited in claim 16, further comprising an acknowledgement step selected from the group consisting of: said slave stack acknowledging to said master stack issuing said hardware command to said hardware manager, said master stack acknowledging to said multi-protocol call manager issuing said transaction to said slave stack, said multi-protocol call manager acknowledging to said user agent stack issuing said transaction to said master stack, and said user-agent stack acknowledging to said remote user agent processing of the Internet telephony command.

23. A method as recited in claim 22, further comprising said user agent stack sending a failed attempt message to the remote user-agent when said acknowledgement step includes a negative acknowledgment.

24. A method as recited in claim 22, wherein said acknowledgment step further includes: including a Service Data Point parameter (SDP) in the acknowledgment.

25. A method as recited in claim 16, wherein said master stack issues said transaction to a slave stack over an IP network;
whereby said Internet telephony command is processed in a loosely coupled mode.

26. A method as recited in claim 16, wherein said Internet telephony command is in the form of an American Standard Code for Information Interchange (ASCII) string of characters.

27. A method for issuing to an Internet telephony endpoint hardware manager a command received from a remote user agent, comprising:
inputting the command received from a remote user agent to a user agent stack;
said user agent stack parsing the command so as to yield a parsed command, and issuing said parsed command to a multi-protocol call manager;
said multi-protocol call manager processing said parsed command yielding a transaction, and issuing said transaction to a master stack; said processing said parsed command including translating said command from an Internet telephony protocol compatible with said user agent stack to an Internet telephony protocol compatible with said master stack;
said master stack issuing said transaction to a slave stack;
and;
said slave stack issuing a hardware command to said hardware manager.

28. A method as recited in claim 27, wherein said remote user agent is selected from a group comprising a SIP user agent and a H.323 user agent.
